(19) United States
(12) Patent Application Publication
(10) Pub. No.: US 2013/0194744 A1
(43) Pub. Date: Aug. 1, 2013

(54) THERMAL CONTROL USING AN ADD-ON MODULE

(71) Applicants: Fu-Yi Chen, Taipei (TW); Tsu Yu Li, Taipei (TW)

(72) Inventors: Fu-Yi Chen, Taipei (TW); Tsu Yu Li, Taipei (TW)

(21) Appl. No.: 13/358,957

(22) Filed: Jan. 26, 2012

(51) Int. Cl. G06F 1/20; F28D 15/00; F28F 7/00

(52) U.S. Cl. 361/679.47; 165/185; 165/104.34; 361/679.54

(57) ABSTRACT

An exemplary embodiment of the present invention includes an add-on module. The add-on module is in contact with a base cooling plate that is connected to a thermal energy transport element and at least one thermal energy generating device when the cooling capacity of the base cooling plate is exceeded by the rating of the thermal energy generating device.

### BACKGROUND

Electronic devices such as all-in-one personal computers (PC) usually include a single enclosure that houses all the computing components of the particular computer with the exception of some user interface devices. For example, the enclosure may include a monitor, central processing unit (CPU), hard drive, memory, and other peripherals such as compact disc (CD) drives. By placing these items into a single enclosure, the need for a separate computing tower is eliminated.

In operation, each component within the enclosure produces thermal energy, or heat. Excess thermal energy can degrade the performance of the all-in-one PC, and can cause components of the all-in-one PC to fail. In order to maintain suitable operating temperatures, all-in-one PCs provide cooling solutions within the single enclosure. Different cooling solutions may be used for enclosures of different sizes with processors of different sizes. Additionally, the same high wattage cooling solution can be used for different processors, even though some higher power processors produce more thermal energy when compared to lower power processors. As a result, a lower power processor could have a cooling solution capable of serving a higher power processor when the lower power processor could be adequately serviced by a lower wattage cooling solution. Accordingly, using the same cooling solution for different processors in the same enclosure is cost inefficient due to the excess cooling capabilities that are unused on lower power processors. Additionally, using different cooling solutions for different enclosures can also be cost inefficient.

### BRIEF DESCRIPTION OF THE DRAWINGS

Certain exemplary embodiments are described in the following detailed description and in reference to the drawings, in which:

FIG. 1 is a perspective view of an all-in-one PC with a cooling unit, in accordance with embodiments;

FIG. 2 is a partial view of the back side of a computing device, in accordance with embodiments;

FIG. 3A is a diagram of a base cooling plate and the front surface of an add-on module in accordance with embodiments;

FIG. 3B is a diagram of the bottom surface of an add-on module in accordance with embodiments;

FIG. 4 is a partial view of the back side of a computing device with the additional add-on module installed in accordance with embodiments;

FIG. 5 is a process flow diagram describing a method of thermal control using an add-on module, in accordance with embodiments; and

FIG. 6 is a process flow diagram describing another method of thermal control using an add-on module, in accordance with embodiments.

### DETAILED DESCRIPTION OF SPECIFIC EMBODIMENTS

In operation, thermal energy is expelled by processors, with faster processors generally expelling more thermal energy than slower processors. Processors may be rated in terms of wattage (W). The wattage signifies the maximum amount of energy the processor can consume under a full workload without risk of failure. Processors with a higher wattage rating may expel more thermal energy than processors with a lower wattage rating, as the high rated processor is able to consume more energy when compared to a lower rated processor. For example, a processor that is rated at 95 W can expel more thermal energy than a processor rated at 65 W. In embodiments, an add-on module is provided that can increase the cooling capacity of a cooling solution. The add-on module works in conjunction with a cooling module to increase the total cooling capacity of the cooling solution.

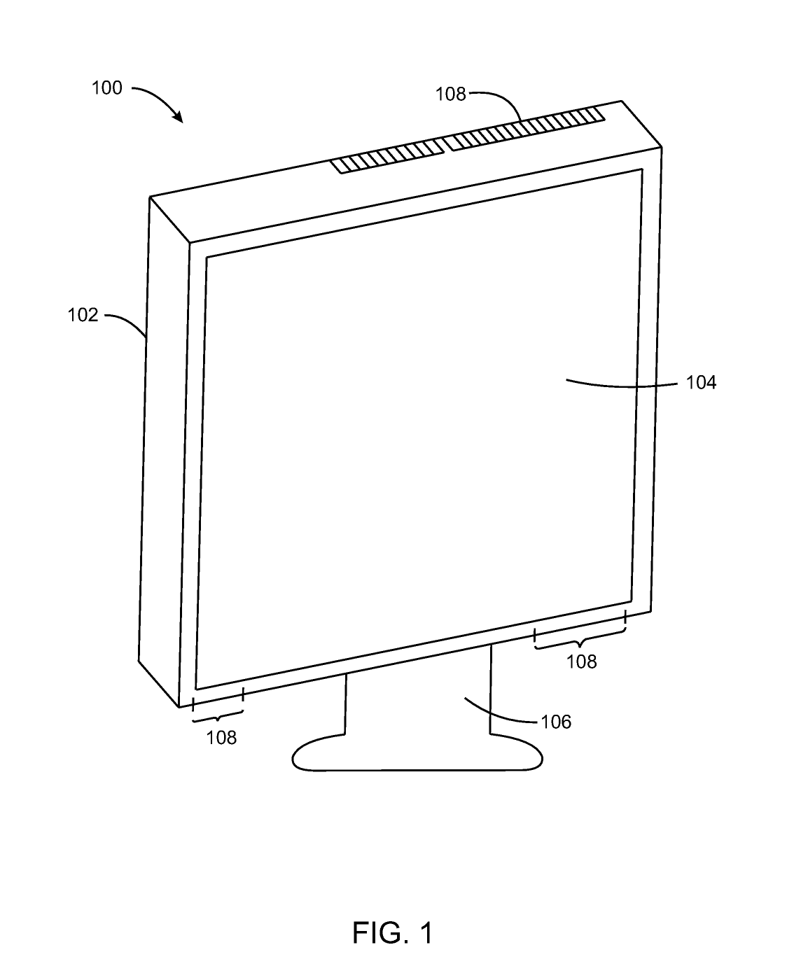

FIG. 1 is a block diagram of an all-in-one personal computer (PC) 100 according to embodiments. The components of the all-in-one PC are enclosed in a case 102. The size of the case 102 may vary depending on the components used for a particular computer or the specifications provided by a purchaser. Within the case 102 is a monitor 104. The case 102 is held upright by a stand 106.

The case 102 may also include air vents 108. The placement of the air vents 108 is dependent upon the arrangement of the cooling solution within the case 102. The air vents 108 allow cool air from outside the case 102 to travel across the components within case 102 and exit from other air vents 108. In this manner, thermal energy is dissipated through the air and a suitable operating temperature can be maintained within the case 102. The case 102 may include an air circulating device that forces cool air across the components within case 102 to dissipate thermal energy from one or more components within the all-in-one PC 100.

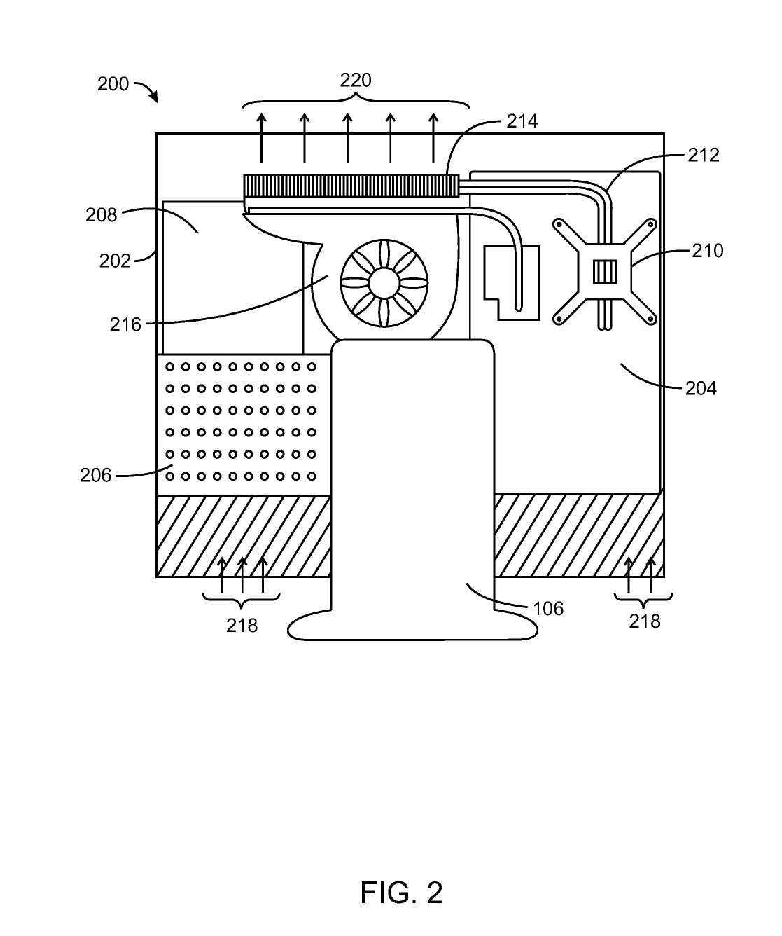

FIG. 2 is a partial view of the back side of a computing device 200 in accordance with embodiments. The computing device 200 may be any suitable computing device, including an all-in-one PC. The computing device 200 may include a case 202 and a stand 106. For example, the case of the computing device 200 may be a 21.5-inch case or a 23-inch case. In other examples, the case can include additional dimensions. Within the case 202 there is a monitor and various other computer components not shown in FIG. 2. Also included in case 202 is a motherboard 204, which is a circuit device that includes electrical connections to other components within the case 202. The motherboard 204 may be connected to a hard disk drive 206 and an optical disk drive 208. Also attached to the motherboard 204 are various thermal energy generating devices, such as a processor, not shown in FIG. 2. A thermal energy generating device is a hardware component of the computing device 200 which can generate thermal energy, or heat, from a load or in response to receiving power from a power source of the computing device 200. Examples of a thermal energy generating device include, but are not limited to, a processor, memory, and disk drive.

Atop the processor is a base cooling plate 210. The base cooling plate 210 may be in contact with a thermal energy transport element 212. The base cooling plate 210 and the thermal energy transport element 212 form a cooling solution that transfers thermal energy away from the processor. The thermal energy transport element 212 may be connected to a thermal energy exchanger 214. An air circulating device 216 may be used to direct air across the thermal energy exchanger 214. In embodiments, the air circulating device 216 is a fan. The air circulating device 216 may be used to direct cool air from the air vents 218 at the bottom of case 202 through the case 202, across the computer components within the case 202, and out of the air vents 220.

In embodiments, the thermal energy transport element 212 may be a flat thermal heat pipe. Thermal energy transport element 212 may comprise any type of thermally conductive element for transferring thermal energy from the base cooling plate 210 and the processor to the thermal energy exchanger 214. In embodiments, the thermal energy exchanger 214 includes a plurality of fins to facilitate thermal energy dissipation from thermal energy exchanger 214. The air from the air circulating device 216 may be directed across the fins of thermal energy exchanger 214. In operation, cooling air is directed from the air circulating device 216 through the thermal energy exchanger 214 to dissipate thermal energy generated by components such as the processor.

In embodiments, the case 202 is open at the air vents 218 and 220 to allow air to enter and escape case 202. It will be understood that the air vents 218 and 220 can be configured on any side of case 202 to allow air to enter and escape case 202 in the cooling solution.

In FIG. 2, the described cooling solution is arranged to cool the lowest power processor amongst the anticipated processor types that may be implemented in accordance with embodiments. For example, the processor may be a 65 W processor within a 21.5-inch case, however any size of case may be used. Accordingly, the cooling solution described in FIG. 2 may also be used to cool a 65 W processor in any size case, including a 23-inch case. In embodiments, the cooling solution may be leveraged to support the cooling of a higher power processor through the use of an add-on module.

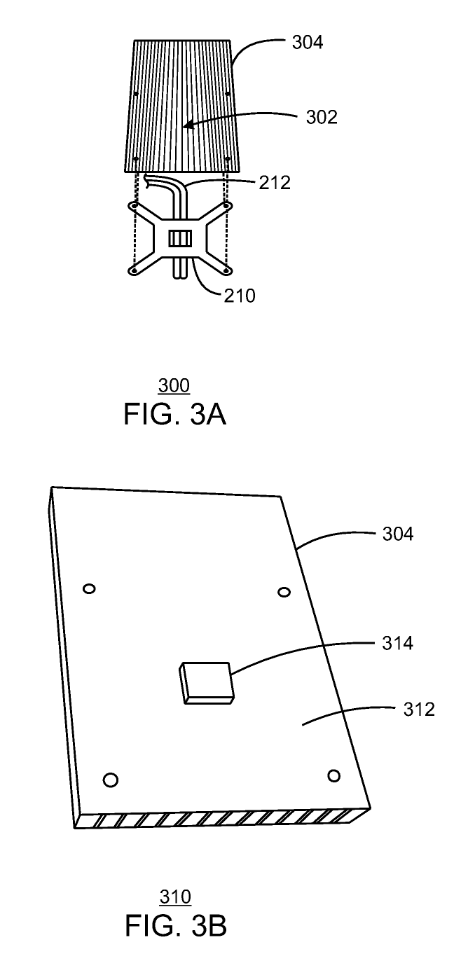

FIG. 3A is a diagram 300 of a base cooling plate 210 and the front surface 302 of an add-on module 304 in accordance with embodiments. As discussed above, the cooling solution including the base cooling plate 210 and the thermal energy transport element 212 may be used for thermal control. For example, the cooling solution may be used with a 65 W processor that can be installed in both the 21.5-inch case and the 23-inch case. In situations where a higher power processor is used, such as a 95 W processor, an add-on module 304 may be used. Thus, the add-on module 304 can be used when the cooling capacity of the base cooling plate 210 is exceeded by the rating of the thermal energy generating device. The rating of a thermal energy generating device is the amount of thermal energy, or heat, output by the thermal energy generating device under a maximum load or in response to receiving a maximum amount of power from a power source of the computing device. The rating of a thermal energy generating device may be obtained from the manufacturer of the thermal energy generating device. The rating of the thermal energy generating device can also be obtained through various other techniques, such as testing the thermal energy generating device to find the rating.

The add-on module 304 shown is a heat sink, however, it will be understood that the add-on module is not limited to a heat sink and includes any module that can dissipate thermal energy or heat. The add-on module 304 includes fins on the front surface 302 that allow thermal energy to be dissipated across the add-on module 304. In embodiments, the add-on module 304 is 80 millimeters wide, 110 millimeters long, and 10 millimeters in height. Additionally, in embodiments, the add-on module 304 has a base that is 2 millimeters thick with fins that are 1 millimeter thick at the fin base and 8 millimeters in height. In other embodiments, the add-on module can include additional dimensions and/or additional components in addition to and/or in lieu of those noted above.

The add-on module can use various methods to dissipate heat. In embodiments, the add-on module 304 is a fan placed in contact with the base cooling plate 210. The add-on module 304 may be in contact with the base cooling plate 210 using spring screws that maintain a 10 pound retention force between the add-on module 304 and the base cooling plate 210. The spring screws may be four M3 spring screws. In other embodiments, the add-on module 304 is an additional thermal transport element in contact with the base cooling plate 210, thermally connected to a remote thermal energy exchanger. Further, a fan may be placed atop the base cooling plate 210 in contact with the additional thermal transport element. The fan may direct air across the remote thermal energy exchanger.

FIG. 3B is a diagram of the bottom surface 312 of the add-on module 304 in accordance with embodiments. The bottom surface 312 of the add-on module 304 is on the opposite side of the front surface 302 (FIG. 3A) of the add-on module 304, and may be disposed in contact with the top surface of the base cooling plate 210. The fins of the add-on module 304 can be used to dissipate thermal energy generated by the high power processor across the add-on module 304. The combination of the add-on module 304 and the base cooling plate 210 can be used to dissipate thermal energy which can exceed the amount of thermal energy dissipated by the base cooling plate alone.

In embodiments, the bottom surface 312 of add-on module 304 includes a thermal pad 314 that enhances heat transfer between the add-on module 304 and the thermal energy transport element 212. A thermal pad is a piece of material used to aid in conducting thermal energy, or heat, away from the thermal energy generating device. While firm at room temperatures, a thermal pad typically becomes pliable at higher temperatures in order to fill gaps between the add-on module 304 and the thermal energy transport element 212.

In embodiments, the thermal pad 314 is 15 millimeter square and 1.5 millimeters in thickness to provide proper contact between the base cooling plate 210 and the add-on module 304. The base cooling plate 210 includes a corresponding opening that enables the thermal pad 314 to access the thermal energy transport element 212. When the add-on module 304 is installed on top of the base cooling plate 210, the thermal pad 314 makes contact with the thermal energy transport element 212. The thermal pad 314 supports thermal conduction between the add-on module 304 to the thermal energy transport element 212. In embodiments, the thermal pad 314 has a thermal conductivity of at least 2.8 watts per meter Kelvin (W/(m·K)). When the thermal pad 314 makes contact with the thermal energy transport element 212, the thermal energy transport element 212 transfers thermal energy from the add-on module 304 and the base cooling plate 210 away from the processor. In embodiments, the add-on module 304 has a 30 W cooling capacity. Additionally, in embodiments, thermal grease or phase-change materials may be used in place of a thermal pad. Thermal grease is a viscous fluid substance that increases the thermal conductivity of the thermal connection between the add-on module 304 and the thermal energy transport element 212 by filling air gaps that occur between the add-on module 304 and the thermal energy transport element 212. Similarly, phase change materials fill the air gaps between the add-on module 304 and the thermal energy transport element 212 by being solid at room temperatures, but changing to a grease like state to fill air gaps at operating temperatures.

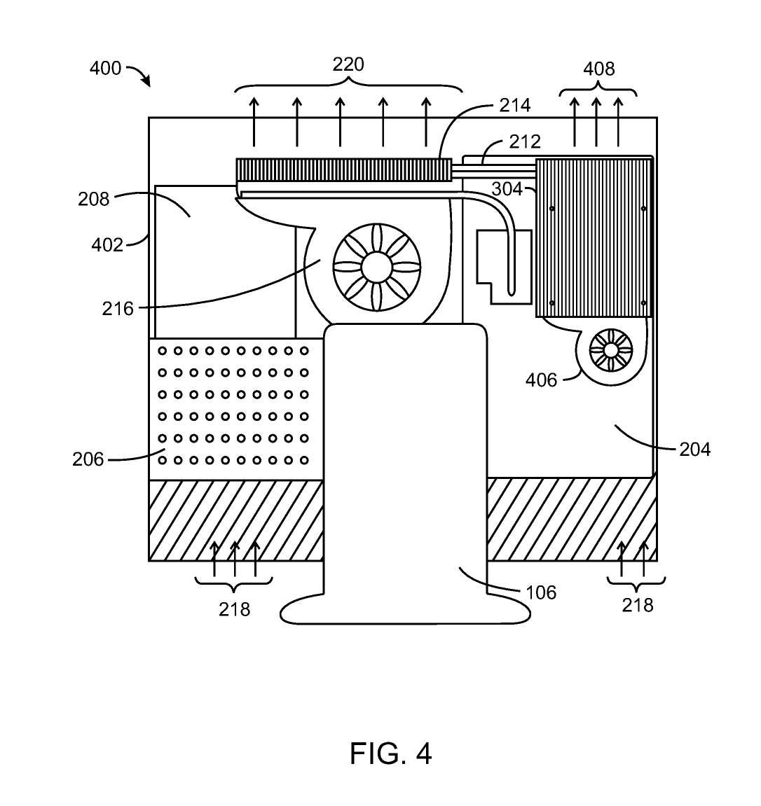

FIG. 4 is a partial view of the back side of a computing device 400 with the additional add-on module installed in accordance with embodiments. The computing device 400 includes a case 402 and a stand 106. The computing device may be any suitable computing device, including an all-in-one PC. The computing device includes a case 402 and a stand 106. Similar to FIG. 2, the case 402 includes a motherboard 204, a thermal energy transport element 212 and a thermal energy exchanger 214. Also, as in FIG. 2, an air circulating device 216 may be used to direct air across the thermal energy exchanger 214. The air circulating device 216 may be used to direct cool air from the air vents 218 at the bottom of case 202 through the case 202, across the computer components within the case 202, and out of the air vents 220.

Attached to the motherboard 204 is a processor, not shown in FIG. 4. Attached to the processor is a base cooling plate, also not shown in FIG. 4. An add-on module 304 rests adjacent to the base cooling plate. The add-on module 304 is shown as a heat sink, and may be connected to the base cooling plate as described above with regard to FIG. 3.

The add-on module 304 transfers thermal energy (heat) away from the processor using a thermal energy transport element 212. The add-on module 304 may include an additional air circulating device 406 located adjacent to the add-on module 304. The additional air circulating device 406 may force air across the add-on module 304 and out of the additional air vent 408. In embodiments, the additional air circulating device 406 is a fan with a minimum air flow of 0.12 meters cubed per minute. Additionally, in embodiments, the additional air circulating device 406 has pressure capacity of 170 Pascals (Pa).

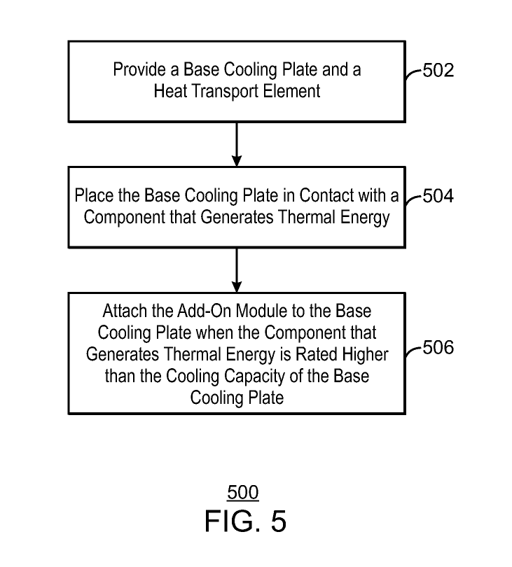

FIG. 5 is a process flow diagram describing a method of thermal control using an add-on module according to embodiments. At block 502, a base cooling plate and a thermal energy transport element is provided. At block 504, the base cooling plate may be placed in contact with a component that generates thermal energy or heat, such as a processor. At block 506, an add-on module is attached to the base cooling plate if the component that generates thermal energy is rated higher than the cooling capacity of the base cooling plate. The add-on module includes a thermal conductive plate having fins that allow thermal energy to be dissipated across the add-on module.

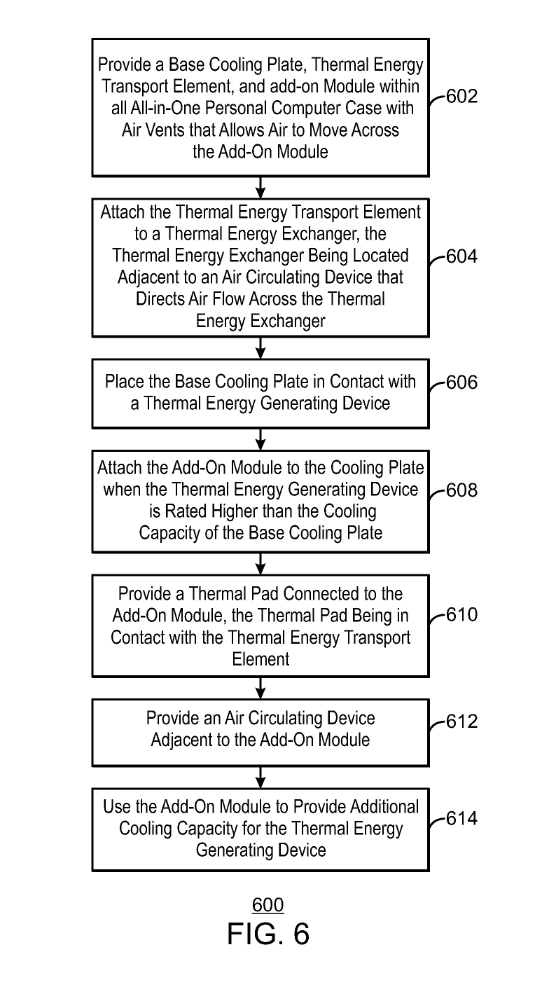

FIG. 6 is a process flow diagram describing another method of thermal control using an add-on module in accordance with embodiments. At block 602, a base cooling plate, thermal energy transport element, and add-on module is provided within an all-in-one PC case with air vents. The all-in-one PC case allows air to move across the add-on module. The add-on module is a heat sink, a fan, an additional thermal transport element, or another additional thermal transport element with a fan disposed atop or adjacent to the another additional thermal transport element. At block 604, the thermal energy transport element is attached to a thermal energy exchanger. The thermal energy exchanger is located adjacent to an air circulating device that directs air flow across the thermal energy exchanger. At block 606, the base cooling plate is placed in contact with a thermal energy generating device. At block 608, the add-on module is attached to the cooling plate when the component that generates thermal energy is rated higher than the cooling capacity of the base cooling plate. At block 610, a thermal pad connected to the add-on module is provided. The thermal pad is in contact with the thermal energy transport element. In embodiments, thermal grease is used in place of the thermal pad. At block 612, an air circulating device is provided adjacent to the add-on module. At block 614, the add-on module is used to provide additional cooling capacity for the thermal energy generating device.

In an example, a 65 W processor may be used to manufacture an all-in-one PC that uses a 21.5-inch case. The same manufacturer may also provide an all-in-one PC in a 23-inch case that may use either a 65 W processor or a 95 W processor. During the manufacturing process, the 65 W processor may be attached to the base cooling plate and thermal energy transport element in either the 21.5-inch all-in-one PC case or the 23-inch all-in-one PC case. However, when the 95 W processor is installed in the 23-inch all-in-one PC case, the base cooling plate and thermal energy transport element alone may not provide enough cooling capacity for the 95 W processor to operate at a suitable temperature. Thus, when the 95 W processor is installed, the add-on module may be attached to the base cooling plate in order to provide enough cooling capacity for the 95 W processor.

As discussed above, the add-on module may include a thermal pad connected to an add-on module, the thermal pad being in contact with the thermal energy transport element. The thermal energy transport element may be connected to a thermal energy exchanger, the thermal energy exchanger being located adjacent to an air circulating device that directs air flow across the thermal energy exchanger. An additional air circulating device may be adjacent to the add-on module. Further, the add-on module may be located within an all-in-one personal computer case with air vents that allow air to move across the add-on module.

Through the use of an add-on module, one cooling solution can be used for both a 65 W processor and a 95 W processor regardless of the case size. The capacity of the cooling solution can be specifically tailored for either processor through the use of an add on module. In this manner the cooling solution is leveraged between the a lower power processor and a higher power processor, such as but not limited to a 65 W processor and the 95 W processor. The use of an add-on module can streamline the manufacturing of computing devices by eliminating the need to know the specific heat generating components that will be installed on a particular computing device ahead of production. In turn, the cost of manufacturing an assortment of computing devices as well as the manufacturing complexity is reduced.

While the present techniques may be susceptible to various modifications and alternative forms, the exemplary embodiments discussed above have been shown only by way of example. It is to be understood that the technique is not intended to be limited to the particular embodiments disclosed herein. Indeed, the present techniques include all alternatives, modifications, and equivalents falling within the true spirit and scope of the appended claims.

What is claimed is:

1. A system, comprising:
a processor connected to a circuit device that includes electrical connections to other components;
a base cooling plate disposed adjacent to the processor and connected to a thermal energy transport element; and
an add-on module in contact with the base cooling plate when the cooling capacity of the base cooling plate is exceeded by the rating of the processor.

2. The system recited in claim 1, wherein the add-on module includes a thermal pad or thermal grease that is in contact with the thermal energy transport element.

3. The system recited in claim 1, wherein the add-on module is a heat sink with fins that allow thermal energy to be dissipated across the add-on module.

4. The system recited in claim 1, wherein an air circulating device is located adjacent to the add-on module.

5. The system recited in claim 1, wherein the thermal energy transport element transports thermal energy away from the processor to a thermal energy exchanger, the thermal energy exchanger being located adjacent to an air circulating device that directs air flow across the thermal energy exchanger.

6. The system recited in claim 1, wherein the add-on module is located within an all-in-one personal computer case with air vents that allow air to move across the add-on module.

7. The system recited in claim 1, wherein the add-on module is at least one of a heat sink, a fan, an additional thermal transport element, and another additional thermal transport element with a fan disposed atop or adjacent to the another additional thermal transport element.

8. A method of thermal control using an add-on module, the method comprising:
providing a base cooling plate and a thermal energy transport element;
placing the base cooling plate in contact with a thermal energy generating device; and
attaching the add-on module to the base cooling plate when the thermal energy generating device is rated higher than the cooling capacity of the base cooling plate.

9. The method recited in claim 8, comprising providing a thermal pad or thermal grease connected to the add-on module, the thermal pad or the thermal grease being in contact with the thermal energy transport element.

10. The method recited in claim 8, comprising providing an air circulating device adjacent to the add-on module.

11. The method recited in claim 8, comprising attaching the thermal energy transport element to a thermal energy exchanger, the thermal energy exchanger being located adjacent to an air circulating device that directs air flow across the thermal energy exchanger.

12. The method recited in claim 8, comprising providing the base cooling plate, thermal energy transport element, and add-on module within an all-in-one personal computer case with air vents that allows air to move across the add-on module.

13. The method recited in claim 8, wherein the add-on module is at least one of a heat sink, a fan, an additional thermal transport element, and another additional thermal transport element with a fan disposed atop or adjacent to the another additional thermal transport element.

14. An add-on module, in contact with a base cooling plate that is connected to a thermal energy transport element and at least one thermal energy generating device when the cooling capacity of the base cooling plate is exceeded by the rating of the thermal energy generating device.

15. The add-on module recited in claim 14, wherein the add-on module includes a thermal pad or thermal grease that is in contact with the thermal energy transport element.

16. The add-on module recited in claim 14, comprising at least a 10 pound retention force between the add-on module and the base cooling plate when the add-on module is in contact with the base cooling plate.

17. The add-on module recited in claim 14, wherein the add-on module is a heat sink that measures 80 millimeters wide, 110 millimeters long, and 10 millimeters in height.

18. The add-on module recited in claim 14, wherein the add-on module is a heat sink with fins that measure 1 millimeter thick at the fin base and 8 millimeters in height.

19. The add-on module recited in claim 14, wherein the add-on module includes a thermal pad that is in contact with the thermal energy transport element, the thermal pad having a thermal conductivity of at least 2.8 watts per meter Kelvin (W/(m·K)).

20. The add-on module recited in claim 14, wherein the add-on module is at least one of a heat sink, a fan, an additional thermal transport element, and another additional thermal transport element with a fan disposed atop or adjacent to the another additional thermal transport element.
